(19) United States
(12) Patent Application Publication
(10) Pub. No.: US 2008/0120119 A1
(43) Pub. Date: May 22, 2008

(54) Method for Servicing an Electronic Certificate for a Big-Name Brand

(76) Inventor: Cheol-Su Lee, Seoul (KR)

Correspondence Address: NOTARO AND MICHALOS, 100 DUTCH HILL ROAD, SUITE 110, ORANGEBURG, NY, 10962-2100, US

(21) Appl. No.: 10/540,997

(22) PCT Filed: Feb. 11, 2005
(86) PCT No.: PCT/KR05/00385

§ 371 Date: Jun. 28, 2005

(30) Foreign Application Priority Data
Feb. 21, 2004 (KR) 10-2004-0011635

(51) Int. Cl. G05B 19/00; G06Q 99/00

(52) U.S. Cl. 705/1; 340/5.8

(57) ABSTRACT

A method for servicing an electronic certificate for a big-name brand. An electronic certificate (1) per goods is created and transmitted to the client (50) such as a mobile phone, etc., through a communication network (40) by request, the electronic certificate (1) comprising an identification code, a secret code, a character image, a management program, etc., and the management program being constructed so as for the electronic certificate (1) to be only able to move after its creation. Then, the character image of the electronic certificate (1) is displayed on the client (50), thereby directly showing possession of the goods of the big-name brand or genuine quality without any authentication. Authentication for the goods can be always achieved.

### TECHNICAL FIELD

The present invention relates to a method for servicing an electronic certificate for a big-name brand, in which an electronic certificate of the big-name brand showing possession of the big-name brand or genuine quality is created and transmitted to a client system such as a mobile phone using communication networks such as a wire/wireless Internet network and displayed on the client system, thereby being able to show ownership of the goods of the big-name brand or genuine quality. Also, authenticating the goods of the big-name brand or genuine quality can be achieved by authentication of the electronic certificate, and the electronic certificate is transferred to another client or a new owner together with transfer of the goods of the big-name brand or genuine quality.

### BACKGROUND ART

Generally, systems for authenticating goods of big-name brands or genuine quality are proposed. As one example, the invention filed with Korean Patent Application No. 10-2001-0024456 on May 4, 2001 and registered with Korean Patent No. 10-0404869 on Oct. 28, 2003 discloses a method of discriminating genuineness of goods from spuriousness of goods for confirming genuineness or spuriousness of goods and a system of confirming genuineness or spuriousness of goods for realizing the method, wherein a discrimination code of genuine quality created by a producer and a code-issuing system according to the invention in common is carryied with, attached to or written on goods or their packing container in the type of an electronic part, a label, marking, etc., and therefore, where distributors, sellers or purchasers desire, they can confirm genuineness or spuriousness of goods in real time by inputting the discrimination code of genuine quality after connecting to a code verification system through the Internet or wire/wireless communication means.

Thus, counterfeit or spurious goods can be easily discriminated by grafting the unimitable or uncounterfeitable discrimination code of genuine quality onto the goods. Also, imitation or reproduction can be prevented originally by recording and perceiving said discrimination code of genuine quality without any exposure thereof by means of separate code creation means and code reading means.

In another method and apparatus for servicing discrimination of genuineness or spuriousness of goods through an RFID card tag and a mobile message, which is disclosed in Korean Patent Laid-open Publication No. 2003-0089045 on Nov. 21, 2003, the gist of the invention is to automatically request discrimination of genuineness or spuriousness of big-name brands or genuine quality goods through a reader device using an RFID card tag, and to authenticate genuineness or spuriousness by a message on genuineness or spuriousness transmitted to the requester's mobile terminal.

### DISCLOSURE

### Technical Problem

However, it is difficult to construct the discrimination code of genuine quality so as not to be exposed, it is inconvenient that authentication of genuineness or spuriousness of goods is always accomplished by inputting the discrimination code or reading the RFID card tag, and another problem is that, without such inquiry, it is difficult to know whether someone has genuine quality.

Accordingly, the present invention is conceived to solve the aforementioned problems and an object of the present invention is to provide a method for servicing an electronic certificate for a big-name brand or genuine quality, in which the electronic certificate of the big-name brand or genuine quality itself can directly show ownership of the goods of the big-name brand or genuine quality by creating an electronic certificate of the goods of the big-name brand showing ownership of the goods of the big-name brand or genuine quality, and by displaying the electronic certificate on the client system such as a mobile phone, in which authentication of the big-name brand or genuine quality can be achieved by authentication of the electronic certificate, and in which the electronic certificate is transferred to another client of a new owner together with transfer of the goods of the big-name brand or genuine quality.

### TECHNICAL SOLUTION

To accomplish the object of this invention, a solution is to be constructed so as to know ownership of goods of a big-name brand or genuine quality just by creating an electronic certificate of the goods comprising an identification code, a secret code, a character image, a management program, etc., moving the electronic certificate along a distribution channel after production of the goods of the big-name brand through an electric/electronic medium such as a wire/wireless network, etc., and displaying the character image of the electronic certificate on a display apparatus of a client system such as a mobile phone, etc., connected to the electric/electronic medium.

That is, a method for servicing an electronic certificate for a big-name brand or genuine quality is provided in accordance with one embodiment of the present invention, the method comprising the steps of: indicating an identification code for goods of the big-name brand or genuine quality with an audio or visual tag, an RFID tag, etc., after setting up the identification code for the goods before the first distribution or the first purchase; requesting creation and transmission of an electronic certificate for the goods by inputting the identification code into an electronic-certificate creation server by means of the audio or visual tag, the RFID tag, etc., at the first distribution or the first purchase, said electronic certificate comprising the identification code, a character image, a management program, etc., and being constructed so that only one electronic certificate can be created when being created and said one electronic certificate can only move after being created; firstly creating the electronic certificate for the goods of the big-name brand or genuine quality at the electronic-certificate creation server; transmitting the firstly created electronic certificate to a client system of the first distributor or the first purchaser such as a mobile phone, a PDA, a computer, etc., through a wire/wireless network such as the Internet, etc.; and displaying the character image of the transmitted electronic certificate on a display apparatus of the client system so as to directly show possession of the goods of the big-name brand or genuine quality without any confirmation or authentication step therefor, and so as for authentication for the goods of the big-name brand or genuine quality to be always able to be achieved.

### ADVANTAGEOUS EFFECTS

Effects by the method for servicing an electronic certificate for goods of a big-name brand in accordance with said one embodiment of the present invention, are that possession of the goods of the big-name brand or genuine quality can be directly known by creating the electronic certificate of the goods of the big-name brand or genuine quality and by displaying the electronic certificate on the client system, that authentication of the goods of the big-name brand or genuine quality can be directly achieved by authentication of the electronic certificate, that a change in ownership of the goods of the big-name brand or genuine quality can be clarified by transferring the electronic certificate to another client of a new owner together with transfer of the goods of the big-name brand or genuine quality, and so forth.

### DESCRIPTION OF DRAWINGS

FIG. 1 is a schematic block diagram showing a construction of a system for realizing a method for servicing an electronic certificate for a big-name brand according to one embodiment of the present invention.

FIG. 2 is a flow chart for explaining the method for servicing the electronic certificate for the big-name brand according to one embodiment of the present invention.

FIG. 3 is a flow chart for explaining further additional construction according to the present invention.

### BEST MODE

Now, preferred embodiments of the present invention will be described in detail with reference to the accompanying drawings.

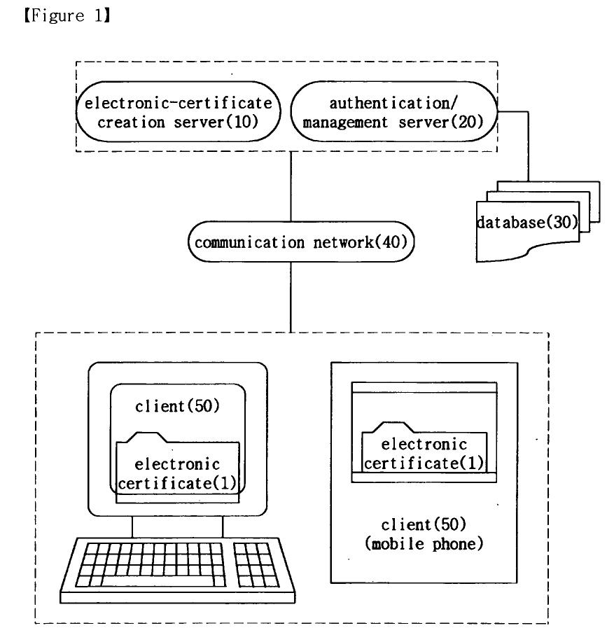

In FIG. 1, a system for realizing a method for servicing an electronic certificate for goods of a big-name brand according to one embodiment of the present invention essentially comprises an electronic-certificate creation server (10), a communication network (40) such as a wire/wireless Internet network and a client (50), which may further comprise an authentication/management server (20) for the electronic certificate for realizing another embodiment of the present invention.

First, in the method for servicing the electronic certificate for the goods of the big-name brand or genuine quality as illustrated in FIG. 2, an identification code for goods of the big-name brand or genuine quality and a secret code for creating the electronic certificate (1) are established and indicated with an audio or visual tag, an RFID tag, etc., before the first distribution or the first purchase of the goods. Then, the identification code and the secret code are inputted into the electronic-certificate creation server (10) by means of the audio or visual tag, the RFID tag, etc., in the client (50) after connection to the electronic-certificate creation server (10) at the first distribution or the first purchase, and creation and transmission of the electronic certificate (1) for the goods are requested. At this time, only details of the goods of the big-name brand or genuine quality may be requested by inputting the identification code of the goods of the big-name brand or genuine quality. The system may be constructed so as to separately input an information about a client (50) to receive transmission, etc., at the time of input and transmission of the secret code for creating the electronic certificate (1) of the goods, and to transmit the electronic certificate (1) to the information-inputted client (50). Also, the character image in shape may be fixed for each goods in the electronic-certificate creation server (10) or be selected among various shapes. Furthermore, it may be desirable for an after-mentioned management program to be constructed so that, in case the information on the client (50) etc., is an electronic mail address, the electronic certificate (1) is loaded and displayed only by clicking a received mail.

As above, the electronic certificate (1) is created in the electronic-certificate creation server (10) and is transmitted to the client (50), and thus the electronic certificate (1) is issued corresponding to the goods of the big-name brand or genuine quality and the character image of the electronic certificate (1) is displayed on the client (50). At this time, it may be desirable to construct a database (30) for later management. The electronic certificate (1) created and issued as above, may be desirably constructed so as to comprise an identification code, a secret code, a character image, a management program, etc., and the management program is desirably constructed so as for the electronic certificate (1) to be only able to move after its creation, that is, so as for the electronic certificate (1) to be cancelled when transmitted or copied, and so as to be capable of requesting confirmation of the goods of the big-name brand or genuine quality or change of rights, applying for a change of the secret code, inputting a new secret code, and so forth.

Meanwhile, in case the secret code is provided in the audio or visual tag, the RFID tag, etc., the secret code for creating the electronic certificate (1) is desirably constructed so as not to be able to be known until the first distribution or the first purchase (in case of the visual tag, by being enclosed with aluminum film), which desirably becomes known at the first distribution or the first purchase. Otherwise, the secret code can be desirably transmitted at the first distribution or the first purchase. Also, it is desirable for the database (30) to comprise information on the electronic certificate (1), a position of the electronic certificate (1), the goods of the big-name brand or genuine quality, the secret code, etc.

Thus, it becomes known to everyone that the owner of the electronic certificate (1) is the owner of the goods of the big-name brand or genuine quality and the goods is acknowledged to be genuine by creating and transmitting the electronic certificate (1) corresponding to the goods at the first distribution or the first purchase and then by displaying the electronic certificate (1) on the client (50) such as a mobile phone, etc.

Furthermore, the step of authenticating the goods of the big-name brand or genuine quality may be included and, a result of a change in ownership of the goods of the big-name brand or genuine quality can be clearly and effectively shown by the electronic certificate (1) which is constructed so as to be transferred to another client of a new owner together with transfer of the goods of the big-name brand or genuine quality.

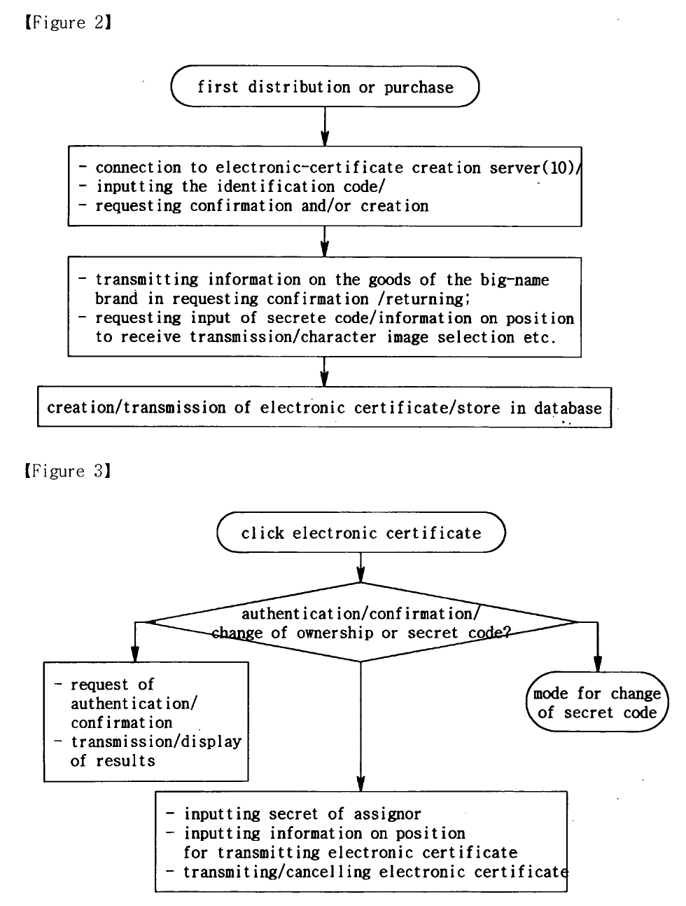

In further another embodiment, information on the created and transmitted electronic certificate (1) and the goods of the big-name brand or genuine quality is recorded in the database (30) at the time of creation and transmission of the electronic certificate (1) by the electronic-certificate creation server (10) in FIG. 1, and then as shown in FIG. 3, it is desirable that, when certification or authentication is requested from the client (50) through the authentication/management server (20), results of the certification or authentication as for the electronic certificate (1) and/or information on the goods of the big-name brand or genuine quality be transmitted in the authentication/management server (20) and be displayed on the client (50).

Still furthermore, as shown in FIG. 3, it is desirable that the electronic certificate (1) be moved to a client (50) of a transferee together with transfer of the goods of the big-name brand or genuine quality and be cancelled from the client (50) of the transferor, thereby a change in ownership of the goods of the big-name brand or genuine quality being achieved. Also, the electronic certificate (1) may be transferred from the client (50) of the transferor to the client (50) of the transferee through the authentication/management server (20). In case it is constructed so that the transfer is achieved only through the authentication/management server (20), management of the electronic certificate (1) becomes feasible.

While, although not shown in the drawings, it may be desirable to comprise the steps of inducing a change in the secret code after the step of transmission of the electronic certificate (1) and changing the previously known secret code in order to prevent movement of the electronic certificate (1) by disclosure of the secret code. Also, the well-known authentication method may be employed for authentication of the electronic certificate (1), etc.

### INDUSTRIAL APPLICABILITY

By virtue of the configuration and acting of the method for servicing an electronic certificate for a big-name brand in accordance with the embodiments of the present invention described above, possession of the goods of the big-name brand or genuine quality can be directly known by creating the electronic certificate per goods of the big-name brand or genuine quality and by displaying the electronic certificate on the client such as a mobile phone, etc. Also, authentication of the goods of the big-name brand or genuine quality can be directly achieved by authentication of the electronic certificate, and a change in ownership of the goods of the big-name brand or genuine quality can be clarified by transferring the electronic certificate to another client of a new owner together with transfer of the goods of the big-name brand or genuine quality.

1: A method for servicing an electronic certificate for a big-name brand or genuine quality, the method comprising the steps of:
indicating an identification code for goods of the big-name brand or genuine quality with an audio or visual tag, an RFID tag, etc., after setting up the identification code for the goods before the first distribution or the first purchase;
requesting creation and transmission of an electronic certificate (1) for the goods by inputting the identification code into an electronic-certificate creation server (10) by means of the audio or visual tag, the RFID tag, etc., at the first distribution or the first purchase, said electronic certificate (1) comprising the identification code, a character image, a management program, etc., and being constructed so that only one electronic certificate can be created per goods when being created and said one electronic certificate can only move after being created;
firstly creating the electronic certificate (1) for the goods of the big-name brand or genuine quality at the electronic-certificate creation server (10) after confirming the identification code;
transmitting the firstly created electronic certificate (1) to a client (50) of the first distributor or the first purchaser such as a mobile phone, a PDA, a computer, etc., through a wire/wireless network (40) such as the Internet, etc.; and
displaying the character image of the transmitted electronic certificate (1) on a display apparatus of the client (50).

2: The method for servicing an electronic certificate for a big-name brand or genuine quality, according to claim 1, wherein a secret code may be provided in the audio or visual tag, the RFID tag, etc., together with the identification code, in which the secret code is able to be first open and known at the first distribution or the first purchase and the secret code being inputted together with the identification code for creating the electronic certificate (1), otherwise the secret code may be transmitted at the first distribution or the first purchase, the electronic certificate (1) comprising the secret code.

3: The method for servicing an electronic certificate for a big-name brand or genuine quality, according to claim 1 or claim 2, wherein a database (30) for the electronic certificate (1) and the goods of the big-name brand or genuine quality is constructed by the electronic-certificate creation server (10) at the time of creation and transmission of the electronic certificate (1), said method further comprising the steps of transmitting results of the certification or authentication as for the electronic certificate (1) and/or information on the goods of the big-name brand or genuine quality when certification or authentication is requested from the client (50) through the authentication/management server (20), and achieving a change in ownership of the goods of the big-name brand or genuine quality by moving the electronic certificate (1) to the client (50) of a transferee together with transfer of the goods and cancelling the electronic certificate (1) from the client (50) of a transferor.

4: The method for servicing an electronic certificate for a big-name brand or genuine quality, according to claim 3, wherein the change in ownership of the goods is achieved by moving the electronic certificate (1) from the client (50) of the transferor to the client (50) of the transferee through the authentication/management server (20).

5: The method for servicing an electronic certificate for a big-name brand or genuine quality, according to claim 1 or claim 3, said method further comprising the steps of inducing a change in the secret code after the step of transmission of the electronic certificate (1), and changing the previously known secret code.
